(19) United States
(12) Patent Application Publication
(10) Pub. No.: US 2026/0095345 A1
(43) Pub. Date: Apr. 2, 2026

(54) DYNAMICALLY MANAGING POWER FOR PROCESSING DEVICES

(71) Applicant: Aivres Systems Inc., Fremont, CA (US)

(72) Inventor: Hung-Shen LIU, New Taipei City (TW)

(21) Appl. No.: 19/413,267

(22) Filed: Dec. 9, 2025

(51) Int. Cl. H04L 12/40

(52) U.S. Cl. CPC H04L 12/40039; H04L 12/40045

(57) ABSTRACT

Methods, devices, circuits, and systems for dynamically managing power for processing devices. In one example, a computing device includes a first processing device, a second processing device, and a controller. The controller is configured to: obtain power consumption information of the first processing device; determine a releasable power based on a predetermined power of the first processing device and the power consumption information of the first processing device; determine an extra current available for the second processing device based on the releasable power; and determine a power parameter for the second processing device based on the extra current and a designated current for the second processing device. The computing device further includes a power regulator coupled to the controller and configured to regulate power to the second processing device based on the power parameter and the designated current.

### TECHNICAL FIELD

The present disclosure is related to computing devices and systems.

### BACKGROUND

Computing devices, such as servers, are widely used in a variety of fields. In areas such as artificial intelligence (AI) and big data, the need for computing is growing rapidly. In modern computing systems, a central computing unit (CPU) and a graphic computing unit (GPU) are combined to provide efficient and high-performance computing. Overclocking has been one of the most widely used technologies to get the most out of CPU performance.

### SUMMARY

The present disclosure describes devices, circuits, systems, methods, and techniques for dynamically managing power for processing devices, e.g., CPUs and/or GPUs.

One aspect of the present disclosure features a device. The device includes a first processing device; a second processing device; a controller; and a power regulator coupled to the controller and configured to regulate power to the second processing device based on the power parameter and the designated current. The controller is configured to: obtain power consumption information of the first processing device; determine a releasable power based on a predetermined power of the first processing device and the power consumption information of the first processing device; determine an extra current available for the second processing device based on the releasable power; and determine a power parameter for the second processing device based on the extra current and a designated current for the second processing device.

In some implementations, the power parameter includes a gain identical to a ratio between the designated current and a sum of the extra current and the designated current.

In some implementations, the designated current is a current set for the second processing device to achieve, and the power regulator is configured to detect a first current of the second processing device and report a second current based on the first current and the power parameter to the second processing device.

In some implementations, the second processing device is configured to adjust a frequency to run to achieve the designated current based on the second current reported by the power regulator.

In some implementations, in a case that the second current reaches the designated current, a third current of the second processing device detected by the controller is greater than the designated current, and for the second processing device, the adjusted frequency to achieve the designated current is higher than a frequency at which the second processing device runs if the power regulator reports the first current, instead of the second current, to the second processing device.

In some implementations, the predetermined power of the first processing device includes a Thermal Design Power (TDP) of the first processing device, and the power consumption information of the first processing device includes a value of a maximum power consumption for the first processing device.

In some implementations, the controller is configured to: obtain the value of the maximum power consumption from a register of the first processing device that is configured to store information of the maximum power consumption while the first processing device is executing one or more corresponding operations or while the first processing device is in a corresponding power state of multiple operations states of the first processing device, different power states corresponding to different maximum power consumptions.

In some implementations, the controller is configured to: determine the value of the maximum power consumption based on at least one of: i) a real-time power consumption of the first processing device while executing an operation, or ii) information of the operation that is being executed by the first processing device.

In some implementations, the controller is configured to: determine the value of the maximum power consumption for the first processing device based on a first load of the first processing device, each load of a plurality of loads of the first processing device being associated with a respective maximum power consumption for the first processing device.

In some implementations, each load is associated with a respective power state, and different power states corresponding to different maximum power consumptions, and the controller is configured to: determine that the first processing device is in a first power state based on the first load of the first processing device, and determine the value of the maximum power consumption based on the first processing device being in the first power state.

In some implementations, the controller is configured to: determine the extra current available for the second processing device based on the releasable power, an efficiency of the power regulator, and an operation voltage of the second processing device.

In some implementations, the controller is configured to: determine the operation voltage of the second processing device by reading a register of the second processing device that is configured to store the operation voltage while the second processing device is performing a corresponding operation, and determine the efficiency of the power regulator by reading a register in the power regulator that is configured to store the efficiency of the power regulator while the power regulator is regulating the power to the second processing device.

In some implementations, the controller is configured to: in response to a change of a power state or a load of the first processing device, update the power consumption information of the first processing device.

In some implementations, the controller is configured to regulate the power to the second processing device based on the power parameter and the designated current, such that a sum of a power consumption of the first processing device and a power consumption of the second processing device remains substantially constant.

In some implementations, the device further includes a first power regulator coupled between the first processing device and a power supply, where the power regulator is a second power regulator coupled between the second processing device and the power supply.

In some implementations, the controller is configured to: write the power parameter into the power regulator through a communication bus between the controller and the power regulator.

In some implementations, the controller includes a least one of a complex programmable logic device (CPLD) or a baseboard management controller (BMC).

In some implementations, the first processing device includes a graphic processing unit (GPU), and the second processing unit includes a central processing unit (CPU).

Another aspect of the present disclosure features a system. The system includes a power supply and a device. The device includes a first processing device; a first power regulator coupled between the first processing device and the power supply and configured to regulate a first power from the power supply to the first processing device; a second processing device; a second power regulator coupled between the second processing device and the power supply and configured to regulate a second power from the power supply to the second processing device; and a controller. The controller is configured to: obtain power consumption information of the first processing device; determine a releasable power based on a predetermined power of the first processing device and the power consumption information of the first processing device; determine an extra current available for the second processing device based on the releasable power; determine a power parameter for the second processing device based on the extra current and a designated current for the second processing device; and transmit the power parameter to the second power regulator to regulate the second power to the second processing device based on the power parameter and the designated current.

Another aspect of the present disclosure features a method. The method includes: obtaining power consumption information of a first processing device; determining a releasable power based on a predetermined power of the first processing device and the power consumption information of the first processing device; determining an extra current available for the second processing device based on the releasable power; determining a power parameter for the second processing device based on the extra current and a designated current for the second processing device; and transmitting the power parameter to a power regulator to regulate power to the second processing device based on the power parameter and the designated current.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a schematic view of an example computing device.

FIG. 2 is a flowchart of an example control process of a method for dynamically managing power for processing devices.

FIG. 3A illustrates some examples of graphically quantitative relationships between reported currents and load currents for processing devices.

FIG. 3B illustrates some other examples of graphically quantitative relationships between reported currents and load currents for processing devices.

FIG. 4 is a flowchart of another example control process of a method of dynamically managing power for processing devices.

FIG. 5 illustrates an example computing device.

FIG. 6 illustrates an example computing system.

Like reference numbers and designations in the various drawings indicate like elements.

### DETAILED DESCRIPTION

Development in computing technology has led to an increasing demand for larger and more sophisticated network communication architectures. A central processing unit (CPU) is an assembly of electronic circuitry that runs an operating system and applications (apps) of a computing device and manages a variety of other computing operations. A graphic processing unit (GPU) is a specialized electronic circuitry configured for graphics rendering and/or a wide range of parallel processing tasks, including gaming, video editing, scientific computing, and artificial intelligence (AI). The CPU and GPU can both be computing (or processing) engines and can also have different architectures configured to emphasize on different tasks. In computing systems, the combination of processing devices, e.g., CPUs and GPUs, can play a key role for providing efficient performance computing (also referred to as high performance computing (HPC)). For example, the combination of CPUs and GPUs can be used in video gaming, machine learning (ML), data analysis, cloud computing, etc.

To ensure safe and efficient operation, the power and thermal issues of these components (e.g., CPUs and GPUs) are important considerations in system design. In some cases, overclocking can be used to get the most out of processor performance, but overclocking can also pose energy efficiency and thermal challenges. Overclocking can be configured to increase the clock rate (also referred to as clock speed or operation frequency) of a processing device, e.g., a processor, beyond its rated speed, which can potentially increase the performance of the processing device.

In some cases, operating parameters of a processing device can be adjusted to balance performance and power consumption. In some cases, dynamic voltage and frequency adjustment (DVFS) technology can be implemented to adjust the voltage and timing of the processing device to accommodate real time workload or the current task. Such adjustment can ensure that the processing device has minimum power consumption while keeping the voltage from the power supply at a level required to maintain performance and quality of service requirements for the real time workload or the current task. For example, if the current task is computationally intensive, which means it requires the processing device to consume more energy and run at a higher frequency, the DVFS can make sure to increase the voltage and frequency of the processor for in increasing performance to match the requirements. If the processing device is running a low-priority or less computationally intensive task where high speed or high throughput is not required, the DVFS can also adjust (e.g., decrease) the voltage and frequency accordingly to save power.

Implementations of the present disclosure provide devices, circuits, systems, methods, and techniques for dynamically managing power for processing devices, e.g., CPUs and/or GPUs. In some implementations, a device (e.g., a computing device) includes a first processing device (e.g., GPU), a second processing device (e.g., CPU), a controller, and a power regulator. The controller is configured to: obtain power consumption information of the first processing device, determine a releasable power based on a predetermined power of the first processing device and the power consumption information of the first processing device, determine an extra current available for the second processing device based on the releasable power, and determine a power parameter for the second processing device based on the extra current and a designated current for the second processing device. The power regulator is coupled to the controller and configured to regulate power to the second processing device based on the power parameter and the designated current. For illustration purposes, a voltage regulator (VR) is described as an example of the power regulator, a GPU is described as an example of the first processing device, and a CPU is described as an example of the second processing device.

The techniques implemented herein can achieve more efficient overclocking under certain conditions. For example, the techniques can overclock the CPU by adjusting the output current (Iₒᵤₜ) of the CPU voltage regulator (VR) while avoiding a power supply unit (PSU) overload when the GPU is not fully loaded. In some cases, the CPU VR can be coupled to the PSU and can provide voltage and current (e.g., Iₒᵤₜ) to the CPU, in other words, the CPU can draw the current from the CPU VR based on the workload or the current task of the CPU. In some cases, the PSU can provide power to a circuit board (such as a motherboard) where the CPU VR and the CPU are integrated on (or mounted on).

In some implementations, the controller can include a complex programmable logic device (CPLD) configured to allow the CPU to draw more current from the CPU VR, when the GPU is not fully loaded, by adjusting a power parameter such as a gain parameter for a monitoring current (Iₘₒₙ) for the CPU. The monitoring current Iₘₒₙ can be a reported current or Iₒᵤₜ return current that the CPU VR reports/returns to the CPU. In some cases, the Iₘₒₙ can be set to a product of the output current Iₒᵤₜ and the gain parameter of the monitoring current Iₘₒₙ Gain. The result of the adjustment can cause CPU overclocking. The techniques can provide a new solution for system performance improvement and power savings within a collection of CPUs and GPUs.

The techniques enable dynamically adjusting power for processing devices and/or among the processing devices. In some cases, the techniques can involve dynamically adjusting the output current (Iₒᵤₜ) of the second processing device (e.g., the CPU) to achieve overclocking under specific load conditions of the first processing device (e.g., the GPU). In these cases, the performance of the second processing device can be enhanced or maximized.

In some implementations, the controller, e.g., a control logic such as a CPLD, can be used to dynamically adjust the output current Iₒᵤₜ of the second processing device such as CPU to ensure that the second processing device is working at a better or optimum level of performance. This process can take place in real time during a processing operation and can be adjusted according to a load condition of the first processing device. By defining different load scenarios for the first processing device, the implementations provided in the preset disclosure can determine when to increase or decrease the output current Iₒᵤₜ of the second processing device to achieve greater performance. It is important to note that these implementations are not just about overclocking the second processing device. By tuning the second processing device's performance without impacting other system components (e.g., overloading the PSU), these implementations are able to achieve a more balanced and optimized an overall system health.

The technical benefits of the present disclosure can include, not limited to, processor performance, energy efficiency, and other enhanced effects for computing devices or systems. For example, the techniques can maximize the performance of the processing device, e.g., by the CPU overclocking effect when another processing device, e.g., the GPU, is not fully loaded, which enables the processing device to respond more quickly to demanding tasks to increase overall system speed and efficiency.

The techniques implemented in the present disclosure can have a wide range of applications, not only in server systems, but also in other computing systems, such as personal computers (PCs), workstations, etc. The techniques for dynamically adjusting powers can be applied not only between different processing devices, but also between a processing device and another type of electronic device or component, or between other electronic components.

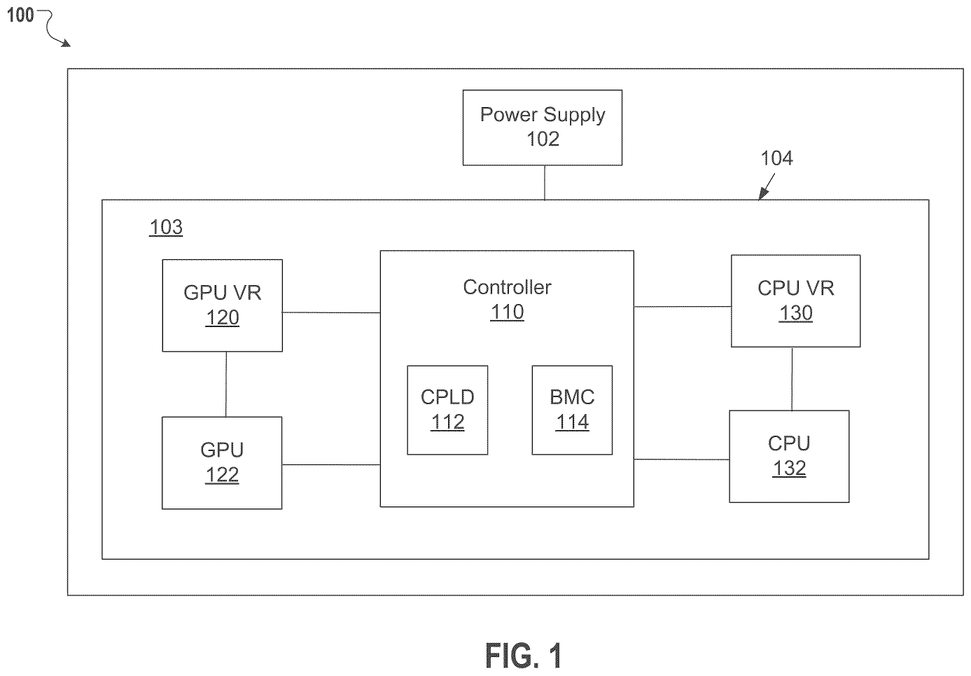

FIG. 1 illustrates a schematic view of an example computing system 100. As shown in FIG. 1, the computing system 100 can include a computing device 104 and a power supply unit (PSU) 102 that supplies power to the computing device 104. The computing device 104 can include a number of electronic components configured to perform different operations. For example, the electronic components can include CPUs, GPUs, multi-core processors, microprocessors, quantum processors, a storage unit (e.g., dynamic random access memory (DRAM), a peripheral component interconnect express (PCIe) unit, or a combination thereof. The computing device 104 can include a circuit board 103, e.g., a motherboard, where the electronic components can be integrated on. The circuit board 103 can be configured to connect internal and external components of the computing device 104 and allows the components to communicate with each other. For example, the circuit board 103 can connect one or more processors, memory, graphics card, and other hardware. The PSU 102 can be integrated on the circuit board 103 or connected externally to the circuit board 103.

In some implementations, as shown in FIG. 1, the computing device 104 can include one or more first processing devices 122 and one or more second processing devices 132. In some implementations, a first processing device 122 can be a CPU, a GPU, an accelerated processing unit (APU), a neural processing unit (NPU), etc. A second processing device 132 can be a CPU, a GPU, an APU, an NPU, etc. In some cases, for the ease of description of the present disclosure, a GPU 122 is described as an example of the first processing device 122, and a CPU 132 is described as an example of the second processing device 132. In these cases, the computing device 104 can include a GPU 122 and a CPU 132.

The computing device 104 can also include a first power regulator (e.g., GPU VR) 120 connected to the GPU 122, and a second power regulator (e.g., CPU VR) 130 connected to the CPU 132. In some cases, the power supply unit 102 can be electrically coupled to the GPU 122 through the GPU VR 120. In these cases, the power supply unit 102 can be configured to supply power to the GPU 122, and the GPU VR 120 can be configured to regulate the power supplied by the power supply unit 102 to the GPU 122. For example, the GPU VR 120 can be configured to maintain a safe operation voltage of the GPU 122 during the operation of the computing device 104. In a similar way, the power supply unit 102 can be electrically coupled to the CPU 132 through the CPU VR 130, and the CPU VR 130 can be configured to regulate the power supplied by the power supply unit 102 to the CPU 132.

In some cases, the CPU VR 130 can detect a first current (e.g., an output current Iₒᵤₜ or a load current) of the CPU 132 while the CPU 132 is running, and report/return to the CPU 132 a second current (e.g., a monitoring current Iₘₒₙ or a reported current). The second current can be same as or different from the detected first current. In some cases, the second current can be equal to a product of the first current and a power parameter (e.g., Gain). Accordingly, the CPU 132 can be configured to adjust an operation frequency based on the second current and a designated current, where the designated current can be a current set for the CPU 132, e.g., for performing a corresponding operation. For example, if the second current is smaller than the designated current, the CPU 132 can increase the operation frequency to achieve the designated current. If the second current is identical to the designated current, the CPU 132 can maintain the operation frequency. In some implementations, the CPU VR 130 can regulate the power supplied by the power supply unit 102 to the CPU 132 based on an inherent efficiency of the CPU VR 130.

The computing device 104 can further include a controller 110 to control the operations of the GPU 122, the CPU 132, the GPU VR 120, and the CPU VR 130. In some cases, the controller 110 can include at least one of a CPLD 112 or a baseboard management controller (BMC) 114. The BMC 114 can be a microcontroller. The BMC 114 can be configured to monitor or detect status of one or more electronic components integrated on the circuit board 103. In some implementations, the BMC 114 is configured to provide administrators with remote access and control over hardware, for example, even when the computing device 104 is powered off or unresponsive. The BMC 112 can be accessible by the administrators via a dedicated Ethernet (or local area network (LAN)) port or a shared network interface, thereby allowing secure remote connections. In some implementations, the CPLD 112 can include one or more programmable logic blocks that are configured to perform various functions. In some implementations, the one or more programmable logic blocks of the CPLD 112 can be freely programmed by the CPU 132, which allows flexibility in designing digital circuits. In some cases, the combined use of the CPLD 112 and the BMC 114 can enhance the control efficiency of the controller 110, improving the overall performance of the computing device 104.

In some cases, the controller 110 can be configured to obtain power consumption information of the GPU 122, where the power consumption information can include at least one of thermal design power (TDP) information, real-time power consumption information, or maximum power consumption information in a power state or during an operation or with a load (or workload). TDP refers to the power consumption under a maximum load of a processing device, e.g., a CPU or a GPU, and can be predefined by a manufacturer of the processing device. The TDP can be an inherent property of the processing device. A system can be designed for the TDP which is the maximum power, which ensures operation to published specifications under the maximum load. Power consumption of the processing device can be smaller than the TDP under a lower load than the maximum load.

The computing device 104 can be configured to ensure real-time detection and adjustment of the power consumption of the CPU 132 and GPU 122 for maintaining the overall system stability and reliability of the computing device 104. In some implementations, the power consumption of the CPU 132 and the GPU 122 can be detected and adjusted by the controller 110 (e.g., the CPLD 112 and/or the BMC 114).

In some cases, the controller 110 can communicate with GPU 122, the GPU VR 120, the CPU 132, and/or the CPU VR 130 through a communication bus according to a communication protocol. For data communication, a communication protocol is a set of rules for data exchange, defining how data is formatted, transmitted, and interpreted. Examples of communication protocols can include transport control protocol/internet protocol (TCP/IP), universal serial bus (BUS) protocol, etc. A communication interface is the physical or logical connection point that allows data to enter or exit a device, like a USB port. A communication bus is the physical pathway, or a group of wires, that connects multiple devices and transfers the data between them, e.g., USB data lines. Through combined work of the communication protocol, the communication interface, and the communication bus, data can be communicated between different devices. A system management bus (SMBus) is an example of such combined work. The SMBus is a communication bus (e.g., a two-wire serial bus) that operates according to a specific communication protocol derived from inter-integrated circuit (I²C) protocol, and is implemented as a two-wire communication interface on a motherboard. Using SMBus can improve system management performance, and can enhance system reliability through monitoring and control of system parameters. In some implementations, electronic components on the circuit board 103 can communicate with one another using SMBus. For example, the controller 110 can communicate with the GPU 122, the GPU VR 120, the CPU 132, and/or the CPU VR 130, through SMBus.

In some implementations, the computing device 104 can further include a platform controller hub (PCH). The PCH can be mounted on the circuit board 103 and is configured to manage various input/output (I/O) interfaces on the circuit board 103 and serve as an intermediary between the CPU 132 and peripherals to route data from connected devices.

In some implementations, the computing device 104 can further include a cooling module. In some cases, the cooling module can include one or more air-cooling devices and/or one or more liquid-cooling devices. For example, a air-cooling device can include a fan configured to blow air into the computing device 104 and provide cooling for the computing device 104 during operation. A liquid cooling device can use a liquid block, a pump, and a liquid-to-air heat exchanger. By transferring device heat to a separate larger heat exchanger using larger, lower-speed fans, the liquid-cooling device can implement quieter operation, increased processor speeds (overclocking), or a balance of both.

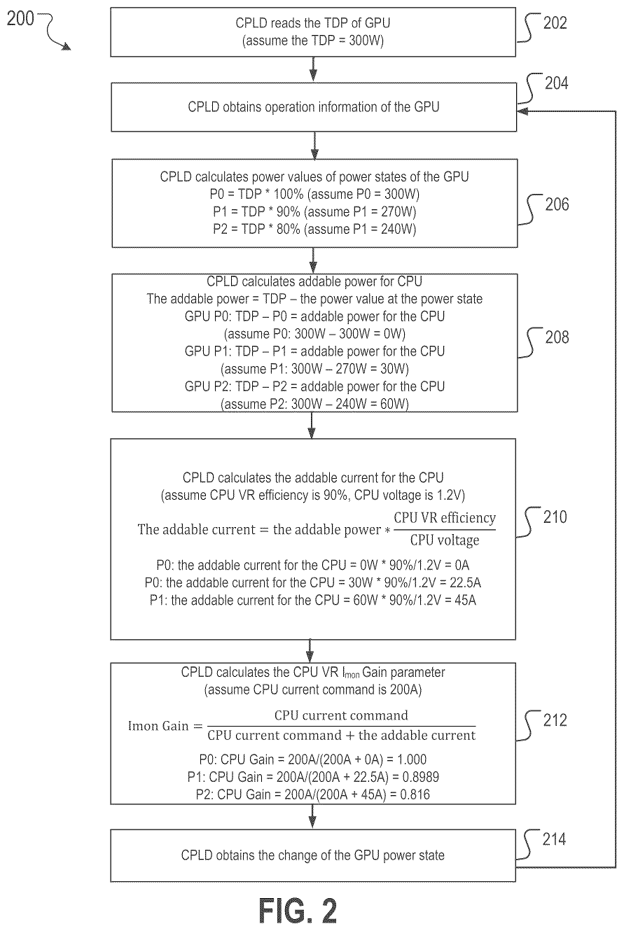

FIG. 2 illustrates a flowchart of an example control process 200 of a method for dynamically managing power for processing devices. For clarity of presentation, the description that follows generally describes methods in the context of the other figures in this description. However, it will be understood that the process 200 can be performed, for example, by any system, environment, software, and hardware, or a combination of systems, environments, software, and hardware, as appropriate. In some implementations, various steps of the process 200 can be run in parallel, in combination, in loops, or in any order. In some implementations, a computing device can perform one or more, or all of the steps described in the process 200. The computing device can be the same as, or similar to, the computing device 104 of FIG. 1. For illustration purpose, a GPU is described as an example of a first processing device (e.g., the first processing device 122 of FIG. 1), a CPU is described as an example of a second processing device (e.g., the second processing device 132 of FIG. 1), and a CPLD is described as an example of a controller (e.g., the controller 110 of FIG. 1). The CPLD can be, e.g., the CPLD 112 of FIG. 1.

Some implementations in the present disclosure detail steps/operations, including GPU power reading, GPU power states definition, CPU power calculation, Iₘₒₙ Gain calculation, Iₘₒₙ Gain setting, and CPU performance enhancement. The implementations highlight how to intelligently tune CPU performance based on GPU's power consumption to increase system performance and energy efficiency.

At operation 202, the CPLD reads GPU maximum power consumption from the GPU. The CPLD can read the maximum power consumption (e.g., TDP) of the GPU (e.g., GPU 122 in FIG. 1) via a communication bus such as SMBus or any other communication protocol. For example, the CPLD can read the value of the predetermined TDP from a register of the GPU through the SMBus. For the ease of description of the present disclosure, the TDP is assumed to be 300 W as an example. In other words, the power consumption of the GPU with 100% of full load is 300 W.

At operation 204, the CPLD can obtain operation information of the GPU. The operation information can include at least one of task information, load information, or maximum power consumption information. In some implementations, the GPU is configured to store a maximum power consumption for running a current task or with a current load or in a power state in a register of the GPU, and the CPLD can read the maximum power consumption for the current task of the GPU from the register of the GPU through the SMBus. The CPLD can also use the maximum power consumption for the current task/operation of the GPU and the TDP to determine power states of the GPU. In some implementations, the CPLD can first obtain the task information and/or the load information, and then determine the maximum power consumption information and/or the power state of the GPU based on the task information and/or the load information, e.g., based on associations between maximum power consumptions and tasks and/or loads. Information of the associations can be stored in the controller or the computing device. A task or load can be associated with a corresponding maximum power consumption. A maximum power consumption can be associated with one or more different tasks or loads.

In some implementations, associations between power states and maximum power consumptions and/or tasks and/or loads can be stored in the controller or the computing device. Each power state can be one to one associated with a different maximum power consumption, and can be associated with one or more corresponding tasks or loads. A task or load can be associated with a corresponding power state. The controller (e.g., the CPLD) can determine a power state of the GPU based on information of a current task of the GPU, or a current load of the GPU, and/or the maximum power consumption of the GPU.

In some cases, the CPLD can use the maximum power consumption for the current task/operation of the GPU to determine a power state of the GPU. For example, the CPLD can detect that a first maximum power consumption for a first task is 300 W, and can determine that the GPU is in a power state P0 corresponding to 300 W. The CPLD can detect that a second maximum power consumption for a second task is 270 W, and can determine that the GPU is in a power state P1 corresponding to 270 W. The CPLD can detect that a third maximum power consumption for a third task is 240 W, and can determine that the GPU is in a power state P2 corresponding to 240 W.

In some cases, the CPLD can obtain from the GPU a first ratio of the current maximum workload of the current task over the full workload. In these cases, the CPLD can use the first ratio and the TDP to define different power states. For example, the CPLD can detect that a first ratio for the first task is 100%, and can determine that the GPU is in a power state P0 as 300 W (100% of the TDP). The CPLD can detect that a second ratio for the current task is 90%, and can determine that the GPU is in a power state P1 as 270 W (90% of the TDP). The CPLD can detect that a third ratio for the third task is 240 W, and can determine that the GPU is in a power state P2 as 240 W (80% of the TDP). Associations with different ratios and different power states can be stored in a register of the GPU.

At operation 206, the CPLD calculates a power value of a power state of the GPU. The GPU can have different power states (or power ratings), e.g., P0, P1, P2. Each power state is defined by a specific power consumption value corresponding to the power state. For example, P0 can be defined as the GPU being with 100% of the full load, with a corresponding power consumption value of 300 W (e.g., 100% of the TDP); P1 can be defined as the GPU being with 90% of the full load, with a corresponding power consumption value of 270 W (e.g., 90% of the TDP); P2 can be defined as the GPU being with 80% of the full load, corresponding to a power consumption value of 240 W (e.g., 80% or the TDP).

At operation 208, the CPLD calculates a releasable power from the GPU, which can be considered as an addable power for the CPU. In other words, the GPU does not need the system to provide a predetermined power such as TDP from a power supply unit (e.g., the PSU 102 of FIG. 1), and the releasable power can be assigned to the CPU for use.

Based on the GPU power state, the CPLD can calculate how much power can be released and added to the CPU for consumption. For example, when the GPU is in P0 state, the GPU has no power for the CPU because the GPU is working with 100% of the full load; when the GPU is in P1 state, the GPU can release 30 W (30 W=300 W−270 W) or 300 W*(100%−90%) of power to the CPU; when the GPU is in P2 state, the GPU can release 60 W (60 W=300 W−240 W) or 300 W*(100%−80%) of power to the CPU. The releasable power can be provided to the CPU without increasing the total power supplied by the power source (e.g., power supply 102 in FIG. 1), which can improve the performance of the CPU while maintaining power efficiency. The addable power for the CPU can be expressed as:

$$CPU addable power = TDP - power value of a power state \qquad ( 1 )$$

where the power value of the power state can be referred to as the maximum power consumption for the GPU corresponding to the power state.

In some cases, the addable power can be directly determined based on the predetermined TDP and the maximum power consumption information obtained in operation 204. For example, the addable power for the CPU can be calculated as the TDP minus the power value (e.g., the maximum power consumption value), which can correspond to a current power state of the GPU. The CPLD can firstly determine the current power state of the GPU by detecting the current task of the GPU. Then the CPLD can calculate the addable power based on the TDP and the power value corresponding to the current power state of the GPU.

For example, when the CPLD detects that the GPU is currently running a first task, the CPLD can determine that the current power state of the GPU is P0 that corresponds to 300 W (equal to TDP). Since the GPU is working with 100% of the full load, the GPU has no power headroom for the CPU, and the addable power for the CPU is 0 W when the GPU is at the P0 state. When the CPLD detects that the GPU is currently running a second task, the CPLD can determine that the current power state of the GPU is P1 that corresponds to 270 W, which means that the GPU at power state P1 can have a stable power headroom of 30 W (TDP as of 300 W−270 W) releasable to the CPU, and the addable power for the CPU is 30 W when the GPU is at the P1 state. When the CPLD detects that the GPU is currently running a third task, the CPLD can determine that the current power state of the GPU is P2 that corresponds to 240 W, which means that the GPU at power state P1 can have a stable power headroom of 60 W (TDP as of 300 W−240 W) releasable to the CPU, and the addable power for the CPU is 60 W when the GPU is at the P2 state.

At operation 210, the CPLD calculates the addable current for the CPU based on the addable power for the CPU determined at operation 208, an efficiency of CPU VR (e.g., CPU VR 130 in FIG. 1), and an operation voltage of the CPU, e.g., as expressed below:

$$CPU addable current = CPU addable power * \frac{CPU efficiency}{CPU voltage} \qquad ( 2 )$$

As an example, the CPU VR is assumed to be 90% efficient and the operating voltage of the CPU is assumed to be 1.2V. The addable current for the CPU can be calculated as below.
Situation at P0: when the GPU is in P0 state, e.g., 100% of the full load, there is no addable current to the CPU because the GPU requires full power.
Situation at P1: when the GPU is in P1 state, e.g., 90% of the full load, the GPU can release a power of 30 W. Assuming the CPU VR is 90% efficient and the CPU is operating at 1.2V, the addable current that can be added to the CPU is

$$22.5 A = 30 W * \frac{90 \%}{1.2 V} .$$

Situation at P2: when the GPU is in P2 state, e.g., 80% of the full load, the GPU can release a power of 60 W. Also assuming that the CPU VR is 90% efficient and the CPU is operating at 1.2V, the current can be added to the CPU is

$$45 A = 60 W * \frac{90 \%}{1.2 V} .$$

As shown in FIG. 2, at operation 210, the CPLD can calculate the addable current (also referred to as extra current) for the CPU, with the assumption that the CPU VR efficiency is 90% and the CPU voltage is 1.2V. In some cases, the CPU voltage can be obtained as VID by the CPLD by reading a register of the CPU. According to the equation (2): when the GPU is at power state P0, the addable power for the CPU is 0 W, and the addable current for the CPU is OA; when the GPU is at power state P1, the addable power for the CPU is 30 W, and the addable current for the CPU is 22.5 A; when the GPU is at power state P1, the addable power for the CPU is 60 W, and the addable current for the CPU is 45 A.

At operation 212, the CPLD performs a calculation of a power parameter Iₘₒₙ Gain. The CPLD can be configured to write the Iₘₒₙ Gain parameter through SMBus to the CPU VR to enable the CPU to overclock and reach a current higher than a designated current for the CPU. For example, the CPLD can detect a first current of the CPU while the CPU is operating, and report/return a second current to the CPU, where the second current is identical to a product of the first current and the power parameter Iₘₒₙ Gain. If Iₘₒₙ Gain is smaller than 1, the CPU can be configured to increase its clock rate or operation frequency (e.g., overclock) to reach the designated current reported by the CPLD. That is, when the second current reported to the CPU is the designated current, the first current at which the CPU is actually running can be higher than the designated current with Iₘₒₙ Gain being smaller than 1.

The power parameter Iₘₒₙ Gain can be expressed as:

$$Imon Gain = \frac{CPU current command}{CPU current commend + CPU addable current} \qquad ( 3 )$$

where the current command is the designated current set for the CPU.

In some cases, the CPU current command can refer to a value of a designated current that the CPU needs to draw from the CPU VR to run a current task of the CPU. In these cases, the designated current can be calculated as the ratio between the maximum power capability of the CPU and the CPU voltage (e.g., VID)). The maximum power capability of the CPU can be obtained by the CPLD by reading a register of the CPU. For the ease of description of the present disclosure, the CPU current command is assumed to be 200 A as an example.

When the GPU is in P0 state, the Iₘₒₙ Gain parameter is determined to be 1 (considering the CPU addable current for P0 state is OA). When the CPU current command is set to 200 A, the Iₒᵤₜ return/report current or the monitoring current Iₘₒₙ (or the second current) from the CPU VR is equal to the detected value. In other words, the CPU stays at a current operation frequency and draws sufficient current to reach the set value of 200 A.

When the GPU is in P1 state, the Iₘₒₙ Gain parameter is determined to be

$$0.8989 = \frac{200 A}{200 A + 22.5 A} .$$

When the CPU current command is set to 200 A, the first current is detected by the CPU VR to 200 A. This allows the CPU VR to report a second current of 179 A=200 A*0.8989, to the CPU. In other words, the CPU VR detects or supplies the CPU with a current of 200 A, but report a current of 179 A to the CPU. Since this value is smaller than the set 200 A, the CPU can increase the operation frequency to draw more current from the CPU VR to reach the set value 200 A. When the current load that the CPU VR supplies to the CPU reaches a third current of 222.5 A, the CPU VR reports a current of 200 A (222.5 A*0.8989=200 A) to the CPU. That is, the CPU actually needs to draw 222.5 A to achieve a reported current of 200 A. Therefore, overclocking the CPU can be achieved by tuning the power parameter Iₒᵤₜ Gain. In some cases, the third current of 222.5 A can be detected by the CPLD.

When the GPU is in P2 state, the Iₘₒₙ Gain parameter is determined to be

$$0.816 = \frac{200 A}{200 A + 45 A} .$$

When the CPU current command is set to 200 A, the CPU current is detected by the CPU VR to 200 A. This allows the CPU VR to report a current of 163.2 A=200 A*0.816. In other words, the CPU VR loads the CPU with a current of 200 A, but reports a second current of 163.2 A to the CPU. Since this value is less than the set 200 A, the CPU can increase the operation frequency to draw more current from the CPU VR to reach the set value. When the current load that the CPU VR supplies to the CPU reaches a third current of 245 A, the CPU VR reports a current of 200 A (245 A*0.816=200 A) to the CPU. That is, the CPU actually needs to draw 245 A to achieve a reported current of 200 A. Therefore, overclocking the CPU is achieved by tuning the power parameter Iₒᵤₜ Gain. In some cases, the third current of 245 A can be detected by the CPLD.

At operation 214, the CPLD can obtain a change of a power state of the GPU. For example, the GPU is currently running a task and at the power state P1. When the GPU switches to run a new task or has a new workload, which can correspond to the power state P2, the CPLD can move to operation 204 to obtain updated operation information (e.g., the maximum power consumption for the new task) of the GPU in a similar way as discussed in operation 204, and can repeat the process 200 to determine the updated Iₘₒₙ Gain parameter correspondingly to dynamically adjust the power for the CPU (e.g., overclocking the CPU).

In some implementations, defining multiple power states for the GPU can allow the computing device to operate more efficiently and stably. For an example, by identifying a power state corresponding to a current task or load of the GPU, the CPLD can determine a releasable power which is constantly stable for the CPU. In other words, the CPLD does not need to monitor the power consumption of the GPU in real time and adjust the releasable power for the CPU continuously when the GPU is working with the same task or load or with a task or load associated with a same power state, which can increase overall efficiency and reduce power overhead for the computing device. The CPLD can detect a new power state of the GPU and adjust the releasable power for the CPU when the GPU is working with a new task or load. Additionally, as each power state is associated with a respective maximum power consumption, the CPLD can determine the releasable power for the CPU based on the respective maximum power consumption. Thus, the CPU can achieve overclocking based on the power state of the GPU without overloading the PSU, which can maintain the stability of the computing device.

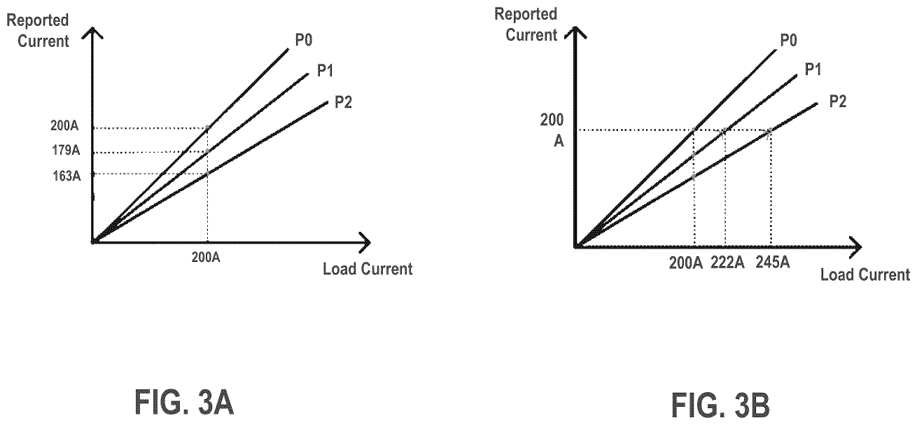

FIG. 3A and FIG. 3B illustrate examples of graphically quantitative relationships between reported current and load current for processing devices. As shown in FIG. 3A, for the GPU being at the P0 state, when the CPU load current output Iₒᵤₜ (a first current) is 200 A, the Iₘₒₙ return (a second current) is 200 A. The slope for the P0 slash is the Iₘₒₙ Gain for the P0 state (1.000). For the GPU being at the P1 state, when the CPU load current output Iₒᵤₜ (a first current) is 200 A, the Iₘₒₙ return (a second current) is 179 A. The slope for the P1 slash is the Iₘₒₙ Gain for the P1 state (0.8989). For the GPU being at the P2 state, when the CPU load current output Iₒᵤₜ (a first current) is 200 A, the Iₘₒₙ return (a second current) is 163 A. The slope for the P1 slash is the Iₘₒₙ Gain for the P2 state (0.816).

As shown in FIG. 3B, when the GPU is at P0 state, the power parameter Iₘₒₙ Gain is 1.000, in order for the CPU VR to return (report) the target value of 200 A, the CPU needs to draw 200 A from the CPU VR. In other words, the CPU is loaded with a current of 200 A by the CPU VR for the target value of 200 A. When the GPU is at P1 state, the power parameter Iₘₒₙ Gain is 0.8989, in order for the CPU VR to return the target value of 200 A, the CPU needs to draw 222 A from the CPU VR. In other words, the CPU is loaded with a current of 222 A by the CPU VR for the target value of 200 A. When the GPU is at P2 state, the power parameter Iₘₒₙ Gain is 0.816, in order for the CPU VR to return the target value of 200 A, the CPU needs to draw 245 A from the CPU VR. In other words, the CPU is loaded with a current of 245 A by the CPU VR for the target value of 200 A.

The above discussed techniques allow the current requirements of the CPU to be adjusted and overclocked based on the load of the GPU, while avoiding the problem of overloading the PSU. Writing the calculated Iₘₒₙ Gain value to the CPU VR via SMBus using the CPLD or similar hardware can trigger the CPU VR to underreport its Iₒᵤₜ, causing the CPU VR to intentionally misreport the lower current, which can enhance inducing the CPU to increase the frequency to get more current.

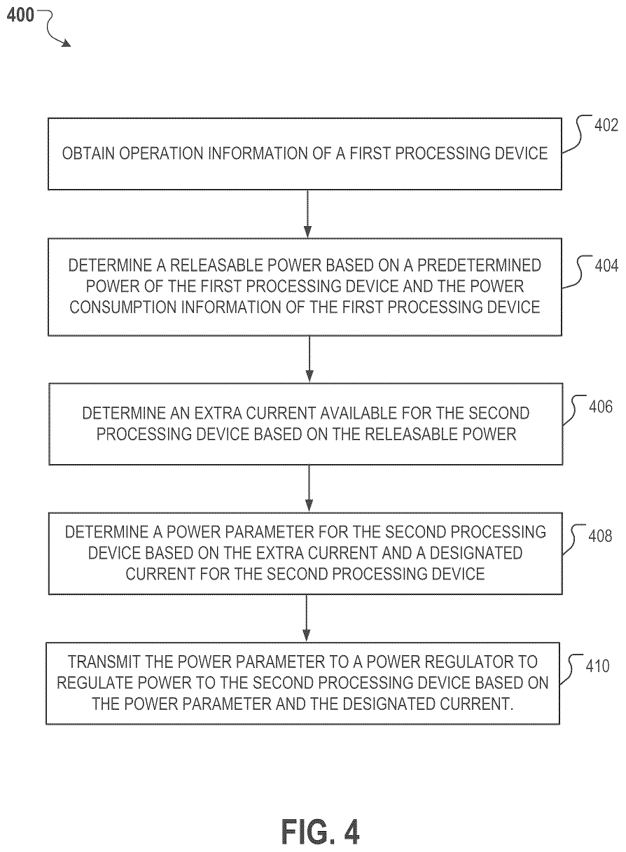

FIG. 4 illustrates a flowchart of another example control process 400 of a method for dynamically managing power for processing devices. For clarity of presentation, the description that follows generally describes methods in the context of the other figures in this description. However, it will be understood that the process 400 can be performed, for example, by any system, environment, software, and hardware, or a combination of systems, environments, software, and hardware, as appropriate. In some implementations, various steps of the process 400 can be run in parallel, in combination, in loops, or in any order. In some implementations, a computing device can perform one or more, or all of the steps described in the process 400. The computing device can be the same as, or similar to, the computing device 104 of FIG. 1.

In some cases, the computing device can include a first processing device, a second processing device, a controller, and a power regulator coupled to the controller. In some cases, the first processing device can include a GPU (e.g., CPU 122 in FIG. 1), and the second processing device can include a CPU (e.g., CPU 132 in FIG. 1). In some cases, the controller can be referred to as the controller 110 in FIG. 1 and can include at least one of a CPLD (e.g., CPLD 112 in FIG. 1) and a BMC (e.g., BMC 114 in FIG. 1). In some cases, the power regulator can include a CPU VR (e.g., CPU VR 120 in FIG. 1). In some cases, the computing device can be included in a system (e.g., computing system 100 in FIG. 1) that also includes a power supply (e.g., power supply unit 102 in FIG. 1). In some cases, the power regulator can be a second power regulator (e.g., the CPU VR 130 of FIG. 1) coupled between the second processing device and the power supply. In some cases, the computing device can further include a first power regulator (e.g., the GPU VR 120 of FIG. 1) coupled between the first processing device and the power supply.

At operation 402, the controller can obtain power consumption information of the first processing device. In some implementations, the power consumption information of the first processing device can include a value of a maximum power consumption for the first processing device. In some implementations, the controller can obtain the value of the maximum power consumption of the first processing device from a register of the first processing device that is configured to store information of the maximum power consumption while the first processing device is executing one or more corresponding operations (or tasks), or while the first processing device is in a corresponding power state of multiple power states of the first processing device, different power states corresponding to different maximum power consumptions. The first processing device can determine the corresponding power state based on a current load or a current task, and the first processing device can determine the maximum power consumption based on the corresponding power state. In these cases, the controller can read from the register the maximum power consumption through a communication bus between the controller and the first processing device.

In some cases, the controller can determine the value of the maximum power consumption based on at least one of: i) a real-time power consumption of the first processing device while executing an operation or task, or ii) information of the operation that is being executed by the first processing device. In some cases, the controller can determine the value of the maximum power consumption for the first processing device based on a load or a current task or a power state of the first processing device. For a plurality of loads or tasks for the first processing device, each load or task can be associated with a respective maximum power consumption for the first processing device. Each power state can be associated with a different maximum power consumption. One or more loads or tasks can correspond to the same maximum power consumption or the same power state. The controller can store associations between maximum power consumptions for the first processing device with tasks/loads/power states for the first processing device.

In some cases, each load can be associated with a respective power state, and different power states can correspond to different maximum power consumptions. The controller can determine that the first processing device is in a first power state based on the first load of the first processing device, and can determine the value of the maximum power consumption based on the first processing device being in the first power state.

At operation 404, the controller can determine a releasable power based on a predetermined power of the first processing device and the power consumption information of the first processing device. The releasable power from the first processing device can be an addable power for the second processing device. In some cases, the predetermined power of the first processing device can include a TDP of the first processing device. In some cases, the controller can be configured to obtain the TDP of the first processing device from a register of the first processing device according to a communication protocol. In these cases, the controller and the first processing device can be configured to communicate through an SMBus. In some cases, the different power states can correspond to different ratios, and the value of the maximum power consumption can be identical to a result of multiplying the TDP and a first ratio corresponding to the first power state. In some cases, the releasable power can be a difference between the TDP and the value of the maximum power consumption for the first processing device, e.g., as illustrated by equation (1).

At operation 406, the controller can determine an extra current available for the second processing device based on the releasable power. In some cases, the extra current can be referred to as an addable current. In some cases, the controller can determine the extra current available for the second processing device based on the releasable power, an efficiency of the power regulator, and an operation voltage of the second processing device. In some cases, the controller can determine the operation voltage of the second processing device by reading a register of the second processing device that is configured to store the operation voltage while the second processing device is performing a corresponding operation, and determine the efficiency of the power regulator by reading a register in the power regulator that is configured to store the efficiency of the power regulator while the power regulator is regulating the power to the second processing device. In some cases, the efficiency of the power regulator can be referred to as the CPU VR efficiency, and the operation voltage read by the controller can be referred to as the CPU voltage (e.g., VID)). In these cases, the extra current can be identical to a ratio between a multiplication of the extra current and the efficiency of the power regulator, and the operation voltage, e.g., as illustrated by equation (2).

At operation 408, the controller can determine a power parameter for the second processing device based on the extra current and a designated current for the second processing device. In some cases, the power parameter can include a gain identical to a ratio between the designated current and a sum of the extra current and the designated current. In some cases, the designated current is a current set for the second processing device to achieve, e.g., for running a corresponding operation. The power regulator can be configured to detect a first current of the second processing device and report a second current based on the first current and the power parameter to the second processing device. In these cases, the second current can be a result of the first current multiplying by the power parameter. In some cases, the second processing device can be configured to adjust a frequency to run to achieve the designated current based on the second current reported by the power regulator.

In some cases, when the second current reaches the designated current, a third current detected by the controller can be greater than the designated current. In some cases, for the second processing device, the adjusted frequency to achieve the designated current can be higher than a frequency at which the second processing device runs if the power regulator reports the first current, instead of the second current, to the second processing device.

In some cases, the controller can be configured to regulate the power to the second processing device based on the power parameter and the designated current, such that a sum of a power consumption of the first processing device and a power consumption of the second processing device remains substantially constant.

At operation 410, the controller can transmit the power parameter to the power regulator to regulate power to the second processing device based on the power parameter and the designated current. In some cases, the controller can be configured to write the power parameter into the power regulator through a communication bus between the controller and the power regulator. In these cases, the communication bus can include an SMBus. In some cases, in response to a change of a power state or a load of the first processing device, the controller can update the power consumption information of the first processing device and repeat the process 400.

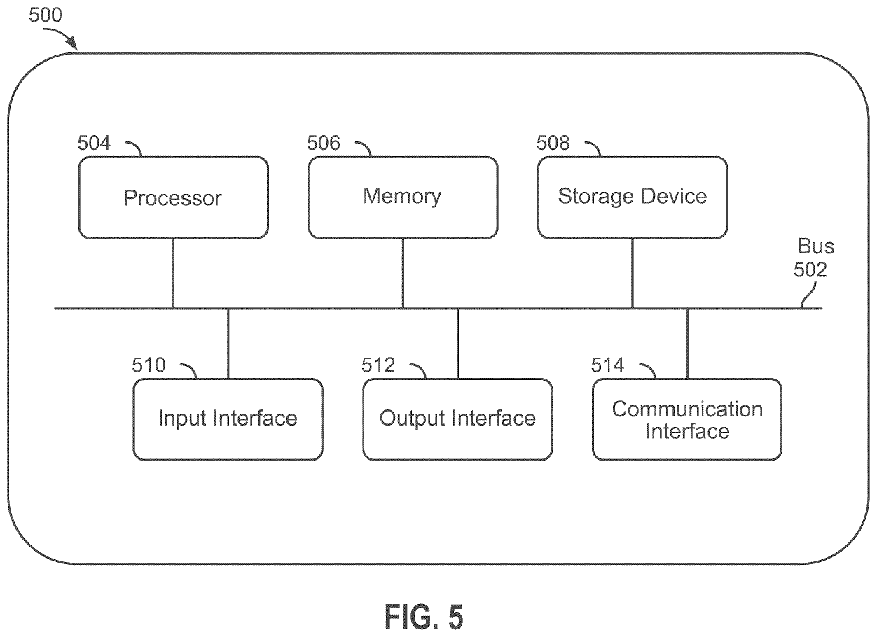

FIG. 5 is a block diagram illustrating an example architecture of a computing device 500 used to provide computational functionalities associated with described algorithms, methods, functions, processes, flows, and procedures. Other architectures are possible, including architectures with more or fewer components. The computing device can be implemented as the computing device 100 of FIG. 1 or the device 200 of FIG. 2. The computing device 500 includes processor 504, memory 506, storage component 508, input interface 510, output interface 512, communication interface 514, and bus 502.

Bus 502 includes a component that permits communication among the components of the computing device 500. In some embodiments, processor 504 is implemented in hardware, software, or a combination of hardware and software. In some examples, processor 504 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 506 includes random access memory (RAM), read-only memory (ROM), and/or another type of dynamic and/or static storage device (e.g., flash memory, magnetic memory, optical memory, and/or the like) that stores data and/or instructions for use by processor 504.

Storage component 508 stores data and/or software related to the operation and use of the computing device 500. In some examples, storage component 508 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 510 includes a component that permits the computing device 500 to receive information, such as via user input (e.g., a touchscreen display, a keyboard, a keypad, a mouse, a button, a switch, a microphone, a camera, and/or the like). Additionally or alternatively, in some embodiments input interface 510 includes a sensor that senses information (e.g., a global positioning system (GPS) receiver, an accelerometer, a gyroscope, an actuator, and/or the like). Output interface 512 includes a component that provides output information from the computing device 500 (e.g., a display, a speaker, one or more light-emitting diodes (LEDs), and/or the like).

In some embodiments, communication interface 514 includes a transceiver-like component (e.g., a transceiver, a separate receiver and transmitter, and/or the like) that permits the computing device 500 to communicate with other devices via a wired connection, a wireless connection, or a combination of wired and wireless connections. In some examples, communication interface 514 permits the computing device 500 to receive information from another device and/or provide information to another device. In some examples, communication interface 514 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 500 performs one or more processes described herein. The computing device 500 performs these processes based on processor 504 executing software instructions stored by a computer-readable medium, such as memory 506 and/or storage component 508. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 506 and/or storage component 508 from another computer-readable medium or another device via communication interface 514. When executed, software instructions stored in memory 506 and/or storage component 508 cause processor 504 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 506 and/or storage component 508 includes data storage or at least one data structure (e.g., a database and/or the like). The computing device 500 is capable of receiving information from, storing information in, communicating information to, or searching information stored in the data storage or the at least one data structure in memory 506 or storage component 508. In some examples, the information includes network data, input data, output data, or any combination thereof.

In some embodiments, the computing device 500 is configured to execute software instructions that are either stored in memory 506 and/or in the memory of another device (e.g., another device that is the same as or similar to the computing device 500). As used herein, the term “module” refers to at least one instruction stored in memory 506 and/or in the memory of another device that, when executed by processor 504 and/or by a processor of another device (e.g., another device that is the same as or similar to the computing device 500) cause the computing device 500 (e.g., at least one component of the computing device 500) to perform one or more processes described herein. In some embodiments, a module is implemented in software, firmware, hardware, and/or the like.

The number and arrangement of components illustrated in FIG. 5 are provided as an example. In some embodiments, the computing device 500 can include additional components, fewer components, different components, or differently arranged components than those illustrated in FIG. 5. Additionally or alternatively, a set of components (e.g., one or more components) of the computing device 500 can perform one or more functions described as being performed by another component or another set of components of the computing device 500.

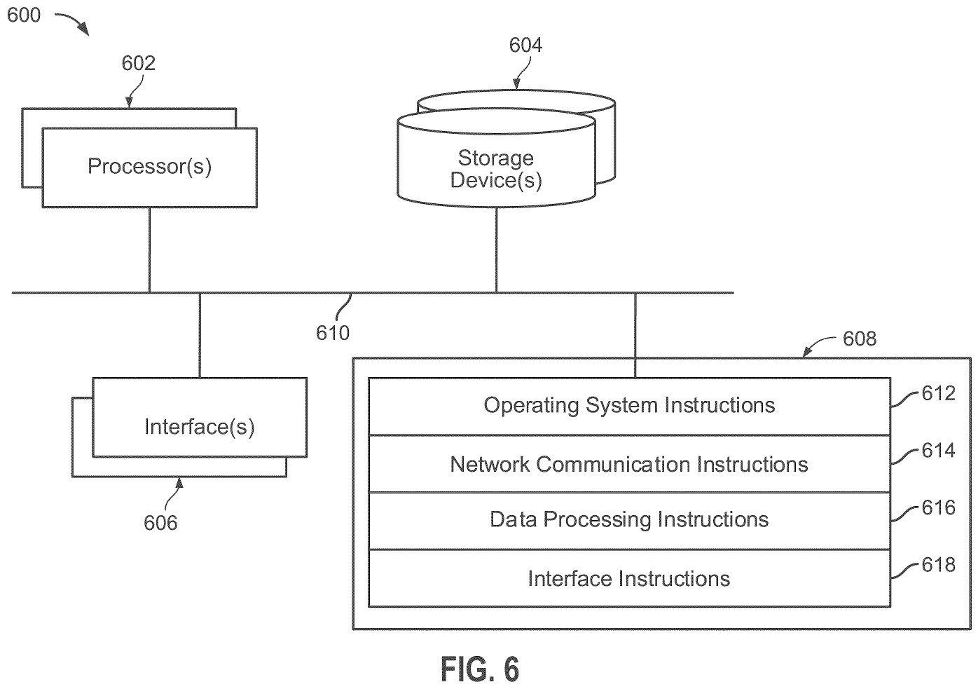

FIG. 6 illustrates an example architecture 600 of a computing system used to provide computational functionalities associated with described algorithms, methods, functions, processes, flows, and procedures. The computing system can include one or more computing devices such as the computing device 100 of FIG. 1 or the device 200 of FIG. 2. Other architectures are possible, including architectures with more or fewer components.

In some implementations, architecture 600 includes one or more processor(s) 602 (e.g., dual-core Intel® Xeon® Processors), one or more network interface(s) 606, one or more storage device(s) 604 (e.g., hard disk, optical disk, flash memory) and one or more computer-readable medium(s) 608 (e.g., hard disk, optical disk, flash memory, etc.). These components can exchange communications and data over one or more communication channel(s) 610 (e.g., buses), which can utilize various hardware and software for facilitating the transfer of data and control signals between components.

The term “computer-readable medium” refers to any medium that participates in providing instructions to the processor(s) 602 for execution, including without limitation, non-volatile media (e.g., optical or magnetic disks), volatile media (e.g., memory) and transmission media. Transmission media includes, without limitation, coaxial cables, copper wire, and fiber optics.

Computer-readable medium(s) 608 can further include instructions 612 for an operating system (e.g., Mac OS® server, Windows® NT server, Linux Server), instructions 614 for network communications module, data processing instructions 616, and interface instructions 618.

Operating systems can be multi-user, multiprocessing, multitasking, multithreading, real time, etc. Operating system performs basic tasks, including but not limited to: recognizing input from and providing output to devices 602, 604, 606 and 608; keeping track and managing files and directories on computer-readable medium(s) 608 (e.g., memory or a storage device); controlling peripheral devices; and managing traffic on the one or more communication channel(s) 610. Network communications module includes various components for establishing and maintaining network connections (e.g., software for implementing communication protocols, such as TCP/IP, HTTP, etc.) and for creating a distributed streaming platform using, for example, Apache Kafka™. Data processing instructions 616 include server-side or backend software for implementing the server-side operations. Interface instructions 618 includes software for implementing a web server and/or portal for sending and receiving data to and from user side computing devices and service side computing devices.

Architecture 600 can be implemented by a cloud computing system and can be included in any computer device, including one or more server computers in a local or distributed network each having one or more processing cores. Architecture 600 can be implemented in a parallel processing or peer-to-peer infrastructure or on a single device with one or more processors. Software can include multiple software components or can be a single body of code.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

It is noted that references in the present disclosure to “one embodiment,” “an embodiment,” “an example embodiment,” “some implementations,” “some implementations,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to affect such feature, structure or characteristic in connection with other implementations whether or not explicitly described.

As used herein, the term “nominal/nominally” refers to a desired, or target, value of a characteristic or parameter for a component or a process step, set during the design phase of a product or a process, together with a range of values above and/or below the desired value. As used herein, the range of values can be due to slight variations in manufacturing processes or tolerances.

As used herein, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or, A and B.” As used herein, the term “and/or” as used herein refers to and encompasses any and all possible combinations of one or more of the associated listed terms. For example, the term “A and/or B” means that either option A, option B, or both options A and B are possible, where A and B may be singular or plural.

As used herein, the term “based on” can be directly based on or indirectly based on. For example, the phrase “based on a voltage” can be interpreted to cover: i) directly based on the voltage; i) indirectly based on the voltage, e.g., directly based on a signal (or voltage) that is generated based on (either directly or indirectly) the voltage. As used herein, the term “about” or “approximately” can allow for a degree of variability in a value or range, for example, within 10%, within 5%, or within 1% of a stated value or of a stated limit of a range. As used herein, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

In addition, the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The breadth and scope of the present disclosure should not be limited by any of the above-described exemplary implementations, but should be defined only in accordance with the following claims and their equivalents.

What is claimed is:

1. A device, comprising:
a first processing device;
a second processing device; and
a controller configured to:
obtain power consumption information of the first processing device;
determine a releasable power based on a predetermined power of the first processing device and the power consumption information of the first processing device;
determine an extra current available for the second processing device based on the releasable power; and
determine a power parameter for the second processing device based on the extra current and a designated current for the second processing device; and
a power regulator coupled to the controller and configured to regulate power to the second processing device based on the power parameter and the designated current.

2. The device of claim 1, wherein the power parameter comprises a gain identical to a ratio between the designated current and a sum of the extra current and the designated current.

3. The device of claim 1, wherein the designated current is a current set for the second processing device to achieve, and
wherein the power regulator is configured to detect a first current of the second processing device and report a second current based on the first current and the power parameter to the second processing device.

4. The device of claim 3, wherein the second processing device is configured to adjust a frequency to run to achieve the designated current based on the second current reported by the power regulator.

5. The device of claim 4, wherein, in a case that the second current reaches the designated current, a third current of the second processing device detected by the controller is greater than the designated current, and
wherein, for the second processing device, the adjusted frequency to achieve the designated current is higher than a frequency at which the second processing device runs if the power regulator reports the first current, instead of the second current, to the second processing device.

6. The device of claim 1, wherein the predetermined power of the first processing device comprises a Thermal Design Power (TDP) of the first processing device, and
wherein the power consumption information of the first processing device comprises a value of a maximum power consumption for the first processing device.

7. The device of claim 6, wherein the controller is configured to:
obtain the value of the maximum power consumption from a register of the first processing device that is configured to store information of the maximum power consumption while the first processing device is executing one or more corresponding operations or while the first processing device is in a corresponding power state of multiple operations states of the first processing device, different power states corresponding to different maximum power consumptions.

8. The device of claim 6, wherein the controller is configured to:
determine the value of the maximum power consumption based on at least one of: i) a real-time power consumption of the first processing device while executing an operation, or ii) information of the operation that is being executed by the first processing device.

9. The device of claim 6, wherein the controller is configured to:
determine the value of the maximum power consumption for the first processing device based on a first load of the first processing device, each load of a plurality of loads of the first processing device being associated with a respective maximum power consumption for the first processing device.

10. The device of claim 9, wherein each load is associated with a respective power state, and different power states corresponding to different maximum power consumptions, and
wherein the controller is configured to:
determine that the first processing device is in a first power state based on the first load of the first processing device, and
determine the value of the maximum power consumption based on the first processing device being in the first power state.

11. The device of claim 1, wherein the controller is configured to:
determine the extra current available for the second processing device based on the releasable power, an efficiency of the power regulator, and an operation voltage of the second processing device.

12. The device of claim 11, wherein the controller is configured to:
determine the operation voltage of the second processing device by reading a register of the second processing device that is configured to store the operation voltage while the second processing device is performing a corresponding operation, and
determine the efficiency of the power regulator by reading a register in the power regulator that is configured to store the efficiency of the power regulator while the power regulator is regulating the power to the second processing device.

13. The device of claim 1, wherein the controller is configured to:
in response to a change of a power state or a load of the first processing device, update the power consumption information of the first processing device.

14. The device of claim 1, wherein the controller is configured to regulate the power to the second processing device based on the power parameter and the designated current, such that a sum of a power consumption of the first processing device and a power consumption of the second processing device remains substantially constant.

15. The device of claim 1, further comprising a first power regulator coupled between the first processing device and a power supply,
wherein the power regulator is a second power regulator coupled between the second processing device and the power supply.

16. The device of claim 1, wherein the controller is configured to:
write the power parameter into the power regulator through a communication bus between the controller and the power regulator.

17. The device of claim 1, wherein the controller comprises a least one of a complex programmable logic device (CPLD) or a baseboard management controller (BMC).

18. The device of claim 1, wherein the first processing device comprises a graphic processing unit (GPU), and the second processing unit comprises a central processing unit (CPU).

19. A system, comprising:
a power supply; and
a device comprising:
a first processing device;
a first power regulator coupled between the first processing device and the power supply and configured to regulate a first power from the power supply to the first processing device;
a second processing device;
a second power regulator coupled between the second processing device and the power supply and configured to regulate a second power from the power supply to the second processing device; and
a controller configured to:
obtain power consumption information of the first processing device;
determine a releasable power based on a predetermined power of the first processing device and the power consumption information of the first processing device;
determine an extra current available for the second processing device based on the releasable power;
determine a power parameter for the second processing device based on the extra current and a designated current for the second processing device; and
transmit the power parameter to the second power regulator to regulate the second power to the second processing device based on the power parameter and the designated current.

20. A method, comprising:
obtaining power consumption information of a first processing device;
determining a releasable power based on a predetermined power of the first processing device and the power consumption information of the first processing device;
determining an extra current available for the second processing device based on the releasable power;
determining a power parameter for the second processing device based on the extra current and a designated current for the second processing device; and
transmitting the power parameter to a power regulator to regulate power to the second processing device based on the power parameter and the designated current.
